(19) United States
(12) Patent Application Publication
(10) Pub. No.: US 2012/0323595 A1
(43) Pub. Date: Dec. 20, 2012

(54) SYSTEMS AND METHODS FOR NURSE ASSIGNMENT AND PATIENT LIST MANAGEMENT INTERACTION WITH ELECTRONIC HEALTH RECORD

(75) Inventors: Faye Hawkins, Seattle, WA (US); Charlotte Christy, Seattle, WA (US); Julian Langford, Seattle, WA (US); Joel Ronald Gray, Tucson, AZ (US); Jon Griep, Seattle, WA (US); Tony Battaglia, Seattle, WA (US)

(73) Assignee: General Electric Company, Schenectady, NY (US)

(21) Appl. No.: 13/482,478

(22) Filed: May 29, 2012

Related U.S. Application Data
(60) Provisional application No. 61/491,048, filed on May 27, 2011.

(51) Int. Cl. G06Q 50/22

(52) U.S. Cl. 705/2

(57) ABSTRACT

Systems, apparatus, and methods to facilitate review and modification of patient assignment are provided. An example method includes displaying, via a user interface, assignments between a clinician and one or more patients including a status of each assignment between the clinician and each of the one or more patients. The example method includes facilitating, via the user interface, a change in at least one assignment via the user interface. The example method includes propagating the change based on an update to assignment status via the user interface.

### CROSS-REFERENCE TO RELATED APPLICATIONS

This patent claims priority to U.S. Provisional Application Ser. No. 61/491,048, entitled “SYSTEMS AND METHODS FOR NURSE ASSIGNMENT AND PATIENT LIST MANAGEMENT INTERACTION WITH ELECTRONIC HEALTH RECORD,” which was filed on May 27, 2011 and is hereby incorporated herein by reference in its entirety.

### FIELD

The presently disclosed technology generally relates to electronic clinical documentation of patient information and, more specifically, relates to electronic, dynamic capture of patient-clinician assignment information.

### BACKGROUND

Currently, changes in assignment between clinicians and patients occurs in a manual way driven by notes from one clinician to another. Information helps provide a more comprehensive patient record and facilitate improved patient diagnosis and treatment. Electronic systems provide electronic medical records, but clinicians are often left without appropriate tools for information capture and documentation.

### SUMMARY

Certain examples provide systems, apparatus, and methods to facilitate review and modification of patient assignment.

Certain examples provide a method including displaying, via a user interface, assignments between a clinician and one or more patients including a status of each assignment between the clinician and each of the one or more patients. The example method includes facilitating, via the user interface, a change in at least one assignment via the user interface. The example method includes propagating the change based on an update to assignment status via the user interface.

Certain examples provide a tangible computer-readable storage medium including instructions for execution by a processor, the instructions when executed implementing a method to facilitate patient assignment. The example method includes displaying, via a user interface, assignments between a clinician and one or more patients including a status of each assignment between the clinician and each of the one or more patients. The example method includes facilitating, via the user interface, a change in at least one assignment via the user interface. The example method includes propagating the change based on an update to assignment status via the user interface.

Certain examples provide a system including a processor and a memory, the memory storing instructions to enable the processor to implement a user interface. The user interface is arranged to display assignments between a clinician and one or more patients including a status of each assignment between the clinician and each of the one or more patients. The example interface is arranged to facilitate a change in at least one assignment via the user interface. The example interface is arranged to propagate the change based on an update to assignment status via the user interface.

### BRIEF DESCRIPTION OF THE DRAWINGS

FIG. 1 is a block diagram of an example healthcare environment in which the example methods, apparatus, systems, and/or articles of manufacture disclosed herein may be implemented.

FIG. 2 depicts an example nursing roster interface.

FIG. 3 illustrates an example nursing assignment interface.

FIGS. 4-5 depict portions of an example nursing assignment interface.

FIG. 6 provides an example interface to manage one or more patient lists.

FIG. 7 illustrates an example physician home base interface.

FIG. 8 illustrates an example interface to facilitate a change in patient-clinician assignment.

FIG. 9 depicts an example clinician interface facilitating review and adjustment of patient assignment status.

FIG. 10 depicts an example temporary reassignment interface.

FIG. 11 depicts an example home base interface.

FIG. 12 provides a flow diagram for a method to manage patients assigned to a clinician.

FIG. 13 illustrates an example immunization review interface.

FIG. 14 illustrates a flow diagram for a method to view and schedule patient immunizations.

FIG. 15 is a block diagram of an example processor system that may be used to implement the systems, apparatus and methods described herein.

The following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION OF CERTAIN EXAMPLES

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide a clinician a high level overview of the patient(s) to which he or she is currently assigned. Within the example patient assignment overview screen/view (e.g., referred to herein in connection with certain examples as a Home Base), information related to current assessment information is provided, along with an ability to review grouped information, such as recent vital signs, assessment, laboratory data, etc. Certain examples provide relevant clinical information to a nurse and/or other clinician for patient(s) within their care. From a Joint Commission perspective, certain examples provide workflows and ability to identify which nurse was primarily caring for which patient(s) at any given time.

Clinicians can use a “Clinician Home Base” to assist in organizing and prioritizing patient care activities during a shift. A clinician's active patient list shows a condensed view of pertinent details about each patient and provides alerts for activities such as new orders review, medication due charting, new lab results, etc.

From the Clinician Home Base, clinicians can access specific functions, such as worklist charting, new order review, etc., by clicking on a corresponding cell in a table of the view. In certain examples, a portion (e.g., a bottom portion) of the Clinician Home Base displays patient-specific findings and shared notes for the current admission.

In certain examples, Clinician Home Base provides a single screen for clinicians to aid in accessing patient information. In certain examples, clinicians can review and work with pertinent information for the patients for whom they are caring on a specific shift.

In certain examples, a Clinician Home Base screen can be configured to include information about patient demographics, assessments (e.g., findings), diagnoses, acuity, fall risk, pain, specific orders (e.g., Code status), nurse assignments, etc. In certain examples, the Clinician Home Base screen includes links to associated applications. For example, if a user clicks or otherwise selects in a New Order column for a patient, the system launches an Order List, from which the user can update or review orders.

In certain examples, the Clinician Home Base screen includes a free-text note box, also referred to as the Admission Shared Note. In this box, a user can directly add and delete an admission shared note.

Certain examples provide a nursing assignment module to assign patients to nurses in a healthcare facility (e.g., in a shift, in a department, etc.). In certain examples, nursing rosters can be created to use for making assignments. Using nursing assignment, a user can assign patients to clinicians, for example. Using nursing assignment, a user can set up nursing rosters based on facilities, units, and/or teams, for example. Using nursing assignment, a user can make temporary assignments to cover for breaks or other patient care changes, for example. Using nursing assignment, a user can review a total number of patients, total acuity, and/or average scores of patients under a clinician's care and adjust assignments as needed or desired, for example. Using nursing assignment, a user can add clinicians to a roster while making assignments of patients on an as-needed and/or as-desired basis, for example. Using nursing assignment can allow users making assignments to set their own user preferences, while maintaining some higher level nurse manager preferences that cannot be changed by individual end users, for example. Nursing assignment can provide an ability to set a patient assignment as pending, allowing a nurse to see a visual indicator of new patient(s) assigned, and to accept the patient assignment, for example.

Certain examples provide a nurse assignment module including an administrative application integrated with a clinician homebase. In the administrative module, certain examples facilitate creating a nursing roster, making assignments using existing nurse rosters; adding a clinician to a roster screen; and/or reassigning or ending patient assignments screen. Rather than requiring clinician to manually create and manage their list or lists of patients for which they have clinical patient care responsibilities, certain examples facilitate automated and/or assisted review, management, and reassignment of patients and patient care responsibilities.

Certain examples address several workflow issues regarding patient privacy and clinical responsibilities. Certain examples also provide an ability to temporarily assign patients to covering clinicians, when a nurse has to leave the floor or is unavailable. Certain examples interface with a third party staffing module where the staffing information is available but not integrated with the clinical system. Certain examples provide integrated assignment functionality and workflows with an electronic health record.

Certain examples provide an immunizations module. Using the Immunizations module, clinicians can review patient immunization information and record immunizations administration, both current and historical. In addition, the immunizations module provides immunization records management and printed reports.

In certain examples, a user can view a patient's historical record from a single screen, which can be organized by facility, etc. Data entry and management are each handled on separate screens, for example.

In certain examples, embedded within the functionality is an ability to review a patient's current administered immunizations and schedule immunizations based on a displayed age-appropriate immunization schedule, such as a Center for Disease Control (CDC) immunization schedule. The CDC immunization schedules can be modified and updated based on current standards published by the CDC, for example.

Certain examples allow clinicians to better manage specific immunization schedules for patients, as well as leverage electronic order entry, health maintenance alerts and reporting capabilities of an electronic health record.

Certain examples address government requirements, regulations, and/or guidelines related to patient immunization management and safe medication administration. Certain examples support meaningful use workflows, stage 1, established by the Centers for Medicare & Medicare Services (CMS) and the Office of the National Coordinator for Health Information Technology (ONC). By providing imbedded views of the CDC age specific schedules and overlaying the patient's current immunization status, a provider is better able to manage prescribing and administering the immunizations safely to the patient. Certain examples also provide the ability to set alerts for additional immunizations as they become due or past due.

Certain examples provide integrated healthcare clinical and financial software solutions to help streamline workflow, facilitate collaboration, and improve productivity across a continuum of care. Certain examples help enhance patient safety, increase efficiency and productivity, and enhance the quality of care available. Certain examples provide an integrated platform to help achieve a meaningful-use objective of continuity of care. For example, patients can be followed by clinicians at any location in a hospital system. Certain examples allow medical professionals to set workflow alerts for patients with specific conditions and allow doctors and clinicians to follow the patients over time.

Certain examples facilitate better control over data. For example, certain example systems and methods enable care providers to access real-time patient information from existing healthcare information technology (IT) systems together in one location and compare this information against evidence-based best practices.

Certain examples facilitate better control over process. For example, certain example systems and methods provide condition- and role-specific patient views enable a user to prioritize and coordinate care efforts with an institution's agreed upon practice standards and to more effectively apply resources.

Certain examples facilitate better control over outcomes. For example, certain example systems and methods provide patient dashboards that highlight variations from desired practice standards and enable care providers to identify most critical measures within the context of performance-based care.

Certain examples leverage existing IT investments to standardize and centralize data across an organization. In certain examples, this includes accessing multiple systems from a single location, while allowing greater data consistency across the systems and users.

Entities of healthcare enterprises operate according to a plurality of clinical workflows. Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

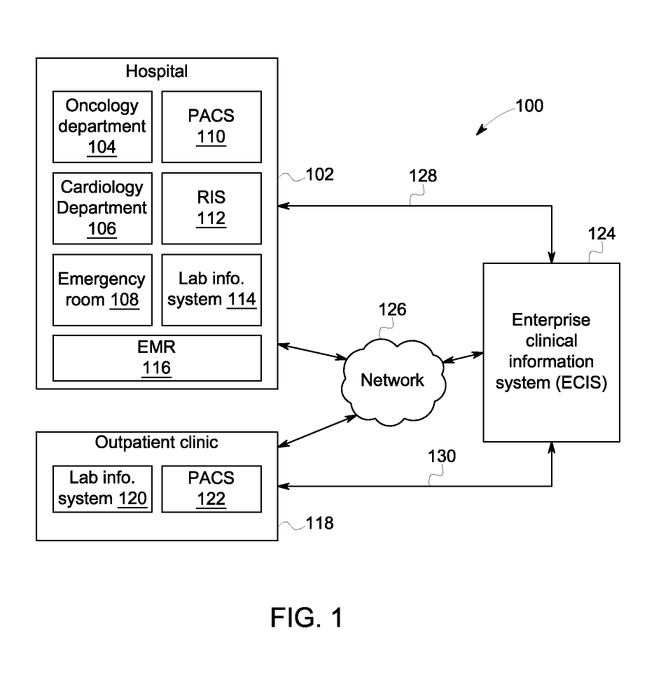

FIG. 1 is a block diagram of an example healthcare environment 100 in which the example methods, apparatus, systems, and/or articles of manufacture disclosed herein for physician notes and other documentation may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set of actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an enterprise clinical information system (ECIS) 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

Certain examples provide a library of standardized clinical content and proven best practices. Over time, this “library” of content may expand as healthcare organizations add to their own content modules. Because the content is standardized it can be shared and leveraged among organizations using the library and associated clinical knowledge platform. The library and platform help enable organizations to share best practice content. Thus, certain examples provide a clinical knowledge platform that enables healthcare delivery organizations to improve performance against their quality targets.

In certain examples, the ECIS 124 supports and/or includes physician documentation, including online (e.g., Web-based and/or portal accessible) physician documentation and/or physician-focused note writing. Physician in-patent notes can include an admitting note (e.g., admitting history and physical), a progress note, a (preliminary) procedure note (e.g., bedside procedures, operative notes by a surgeon after a procedure, etc), a (preliminary) consult note, a resident/attending note, etc. Emergency Department (ED) physician notes (e.g., multi-author notes), ambulatory notes, discharge notes, handoff notes, (preliminary) nursing assessment notes, physician charge capture notes, and/or specialty notes, etc., can similarly be provided. In certain examples, a notes template is configurable by customer. In certain examples, notes can be integrated with a flowsheet, orders, etc.

In certain examples, patient-clinician assignments and/or relationships can be identified due to clinical events. Records of clinician-patient assignments and/or relationships are maintained to meet regulatory guidelines, requirements, and/or recommendations such as The Joint Commission, Health Insurance Portability and Accountability Act (HIPAA), American Recovery and Reinvestment Act (ARRA) Meaningful Use measures, Certification Commission for Health Information Technology (CCHIT) Certification, etc.

Certain examples capture start/end of care, display and record clinician role (e.g., registered nurse (RN), licensed practical nurse (LPN), licensed vocational nurse (LVN), patient care technician (PCT), nurse assistant (NA), patient care assistant (PCA), nurse technician, etc.). In certain examples, user preferences for assignment, status, list options, etc., can be set. Credentials can be displayed, for example.

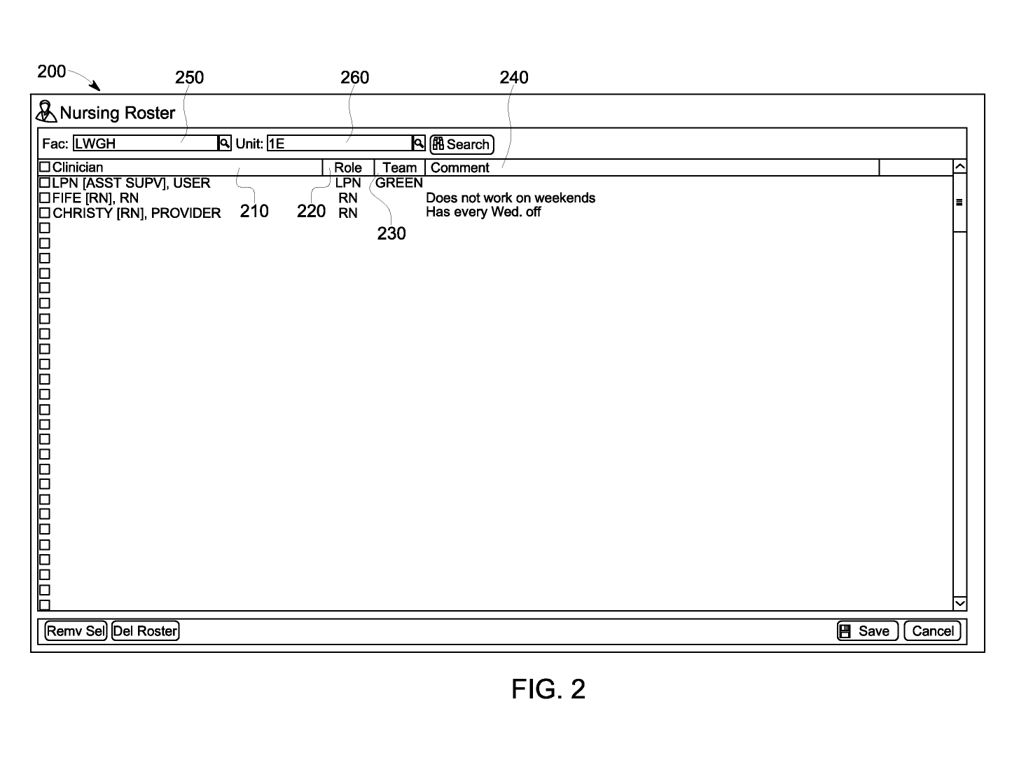

FIG. 2 depicts an example nursing roster interface 200. The nursing roster provides a list of clinicians 210 along with a role 220 and, optionally, a team assignment 230 and/or comment 240, for a facility 250 and/or unit 260. Using the nursing roster 200, a unit 260 can be pre-loaded based on a list of clinicians 210. Using the roster 200, charge nurses, nurse managers, team leads, and others can create unit staff assignment(s). A list of clinicians 210 assigned to a unit 260 can be maintained. The roster 200 can be used to assign a role to a clinician, create team assignment(s), store a comment 240 for individual staff, etc. Nurses can be added on the fly to the list, along with a comment regarding an existing and/or new nurse, for example. The nursing roster interface 200 can be set as a default for a main assignment screen rather than having to build an assignment screen each time.

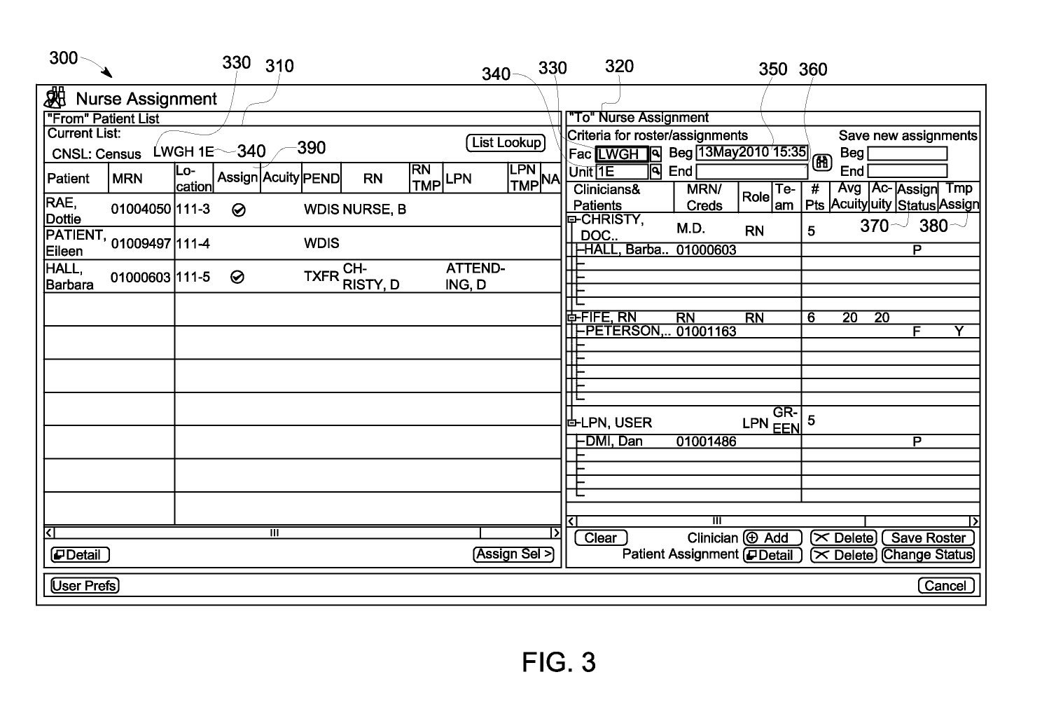

FIG. 3 illustrates an example nursing assignment interface 300. The nursing assignment interface 300 includes a “from” patient list 310 and a “to” nurse assignment list 320. The interface 300 displays a user's default location along with a logged-on user's default facility 330 and unit roster 340. The interface 300 provides tool(s) for balancing assignment and/or patient load. The interface 300 can be used to create assignments with a specific begin 350 and/or end 360 time. The interface 300 provides a status 370 of assignments, such as a “preliminary” assignment so that a clinician can “accept” or acknowledge the assignment via this and/or another interface. A temporary assignment 380 can also be noted. The nursing assignment interface 300 displays a patient's acuity, discharge/transfer, and current assignment statuses, for example. Via the patient list 310, assigned and unassigned status 390 can be viewed, for example.

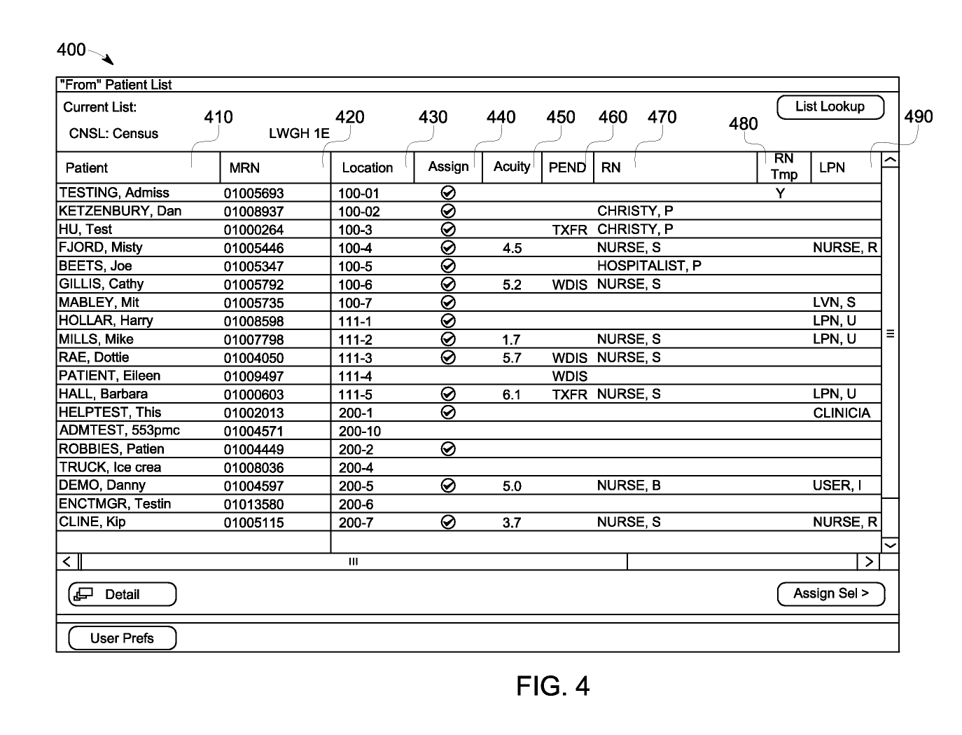

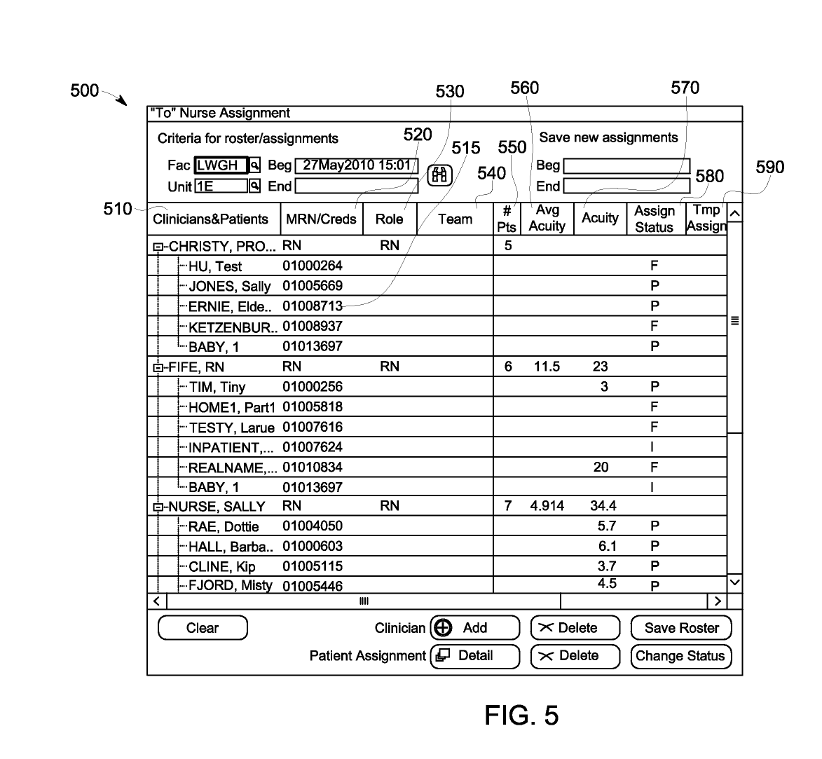

FIG. 4 depicts a portion 400 of a nursing assignment interface providing a patient list 410, identification number 420, location 430, assignment status 440, patient acuity 450, pending order(s) 460, assigned nurse 470, temporary nurse flag 480, licensed practical nurse indicator 490, etc. FIG. 5 depicts a portion 500 of a nursing assignment interface providing a nursing assignment list indicating a list of clinicians 510 and assigned patient(s) 515, identification/credential 520, role 530, team 540, number of patients 550, average acuity 560, patient acuity 570, assignment status 580, temporary assignment indicator 590, etc. Using the interface 500, a clinician can be added or deleted, and a patient assignment can be detailed, changed, deleted, etc.

Thus, via the nurse assignment interface 300, 400, 500, a charge nurse and/or other user can create and manage assignment lists of patients. The assignment lists can be created for individual nurses and/or groups of nurses and nurse extenders and can be created by shift, by role, etc. A nurse is able to adjust begin and end dates and times of care, as well as change a nursing role. Once created, each nurse has the ability to temporarily or permanently assign/reassign a patient to another list so as to provide a continuous coverage of care. “Rosters” based on nursing units can be created with nurses and nurse extenders assigned to them. Team membership can also be maintained on the roster. A user with appropriate authorization can view all providers (e.g., any personnel delivering clinical care) assigned to a patient encounter. Patient assignments can also be displayed in a preliminary state, allowing the nurse to clearly see changes or updates to his or her list at the beginning as well as throughout a shift, for example.

The nurse assignment interface 500 provides an ability to identify and/or filter nursing assignment results based on one or more of location (e.g., facility, unit, etc.), existing assignment time (e.g., begin and/or end), new assignment time (e.g., begin and/or end), etc.

The assignment interface 300, 400, 500 provides one to one assignment of nurses and patients and an ability for nurses to hand off patient(s) from nurse to nurse. The interface 300, 400, 500 can help a nurse manager or charge nurse to manage his/her team. The nursing assignment interface is complementary to a worklist and can be used to create a patient list. An authorized user can assign nurses to patients, based on acuity, etc. A user can select one or more patients at a time and assign them to a nurse. A user can see patients that are already assigned to a nurse (or other clinician).

In certain examples, using an assignment interface, a user can drag patient(s) onto a nurse and to form the nurse's roster. An assignment can be temporary and then finalized. The interface can facilitate workload balancing for nurses. An indicator can be displayed in relation to a patient to indicate that a patient does not have a nurse assigned, has not been seen in awhile, etc. Temporary staff (e.g., clinician(s) not saved to a roster) can be accommodated as well. Nurses can be grouped into teams and displayed via the interface. In certain examples, criterion(-ia) are used to automatically map or suggest patients to nurses, etc. Pending transfer/discharge and/or other information can be provided, along with roster comment(s).

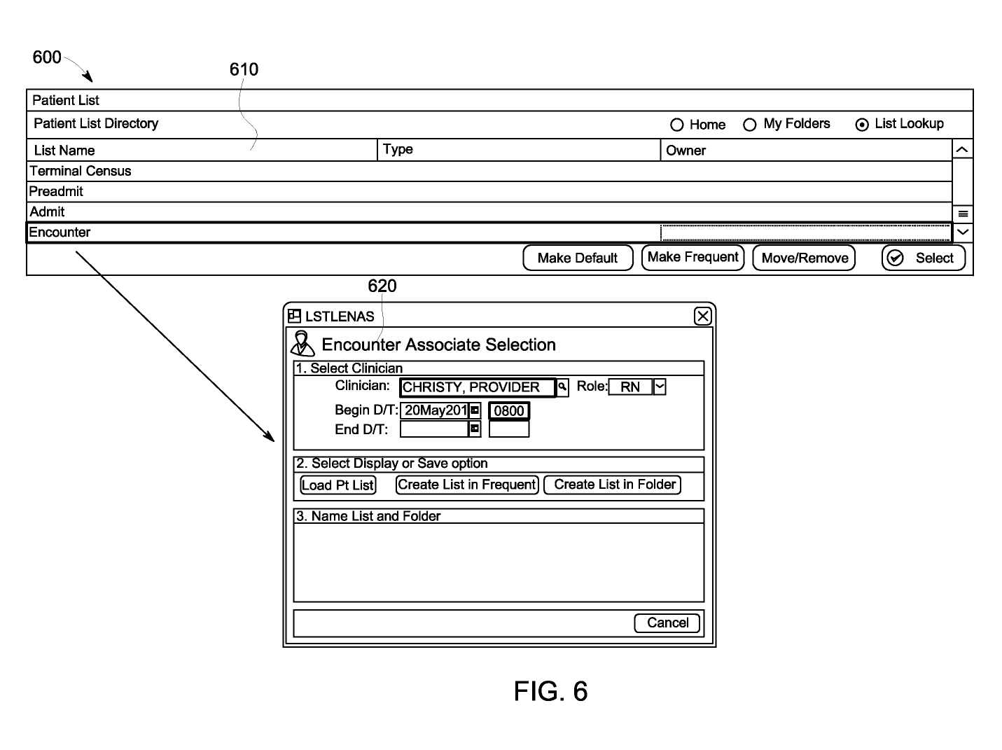

FIG. 6 provides an example interface 600 for managing one or more patient lists 610. A clinician 620 can be selected for association with a patient list 610. Additional information, such as a begin and/or end date, role, etc., can also be specified via the clinician encounter selection interface 620.

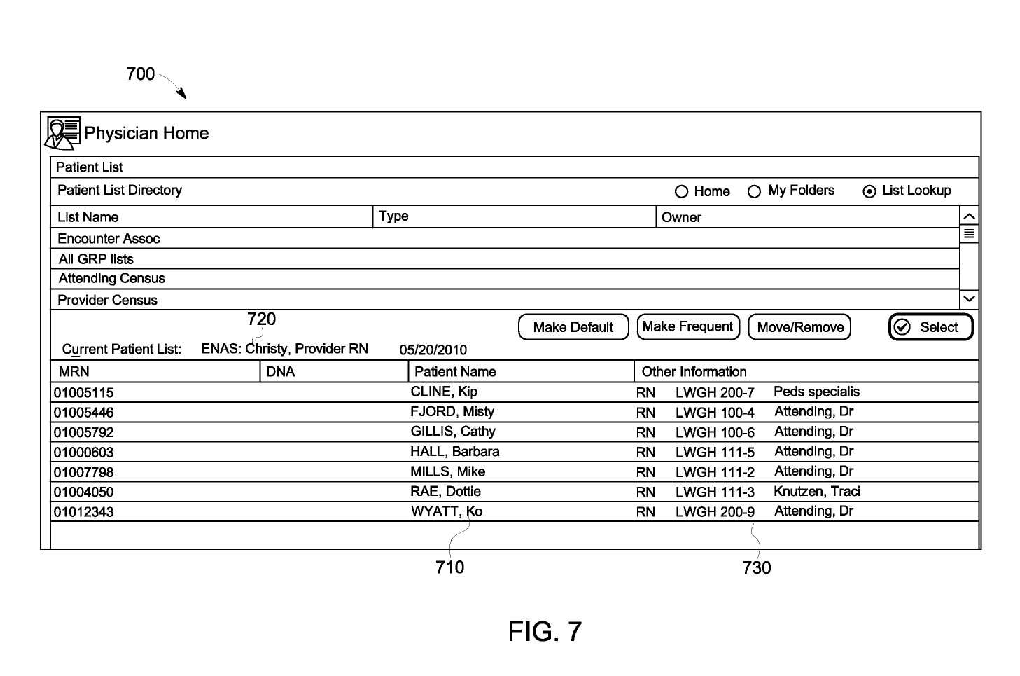

FIG. 7 illustrates an example physician homebase interface 700 including a current patient list 710 for a selected clinician 720 including associated information 730. Thus, a physician can see a list of patients associated with each nurse 720 in his or her area, for example.

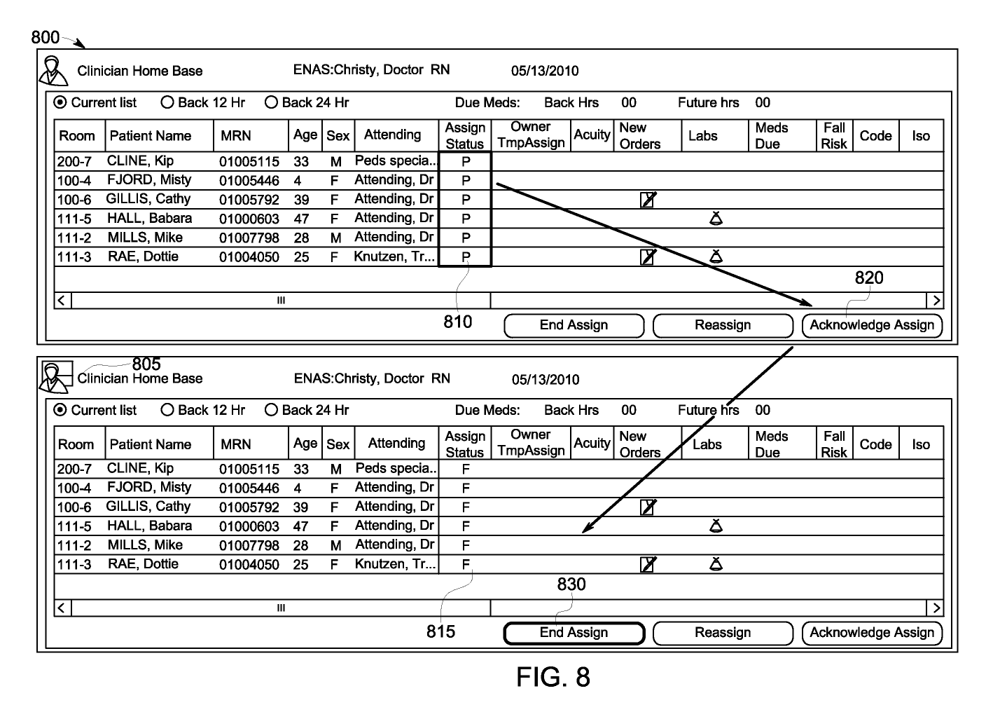

As illustrated in the example interfaces 800, 805 of FIG. 8, a set of temporary assignments 810 can be acknowledged to become finalized assignments 815 by facilitating user acknowledgement 820. A user can then complete the assignment 830 via the clinician home base interface 800, 805.

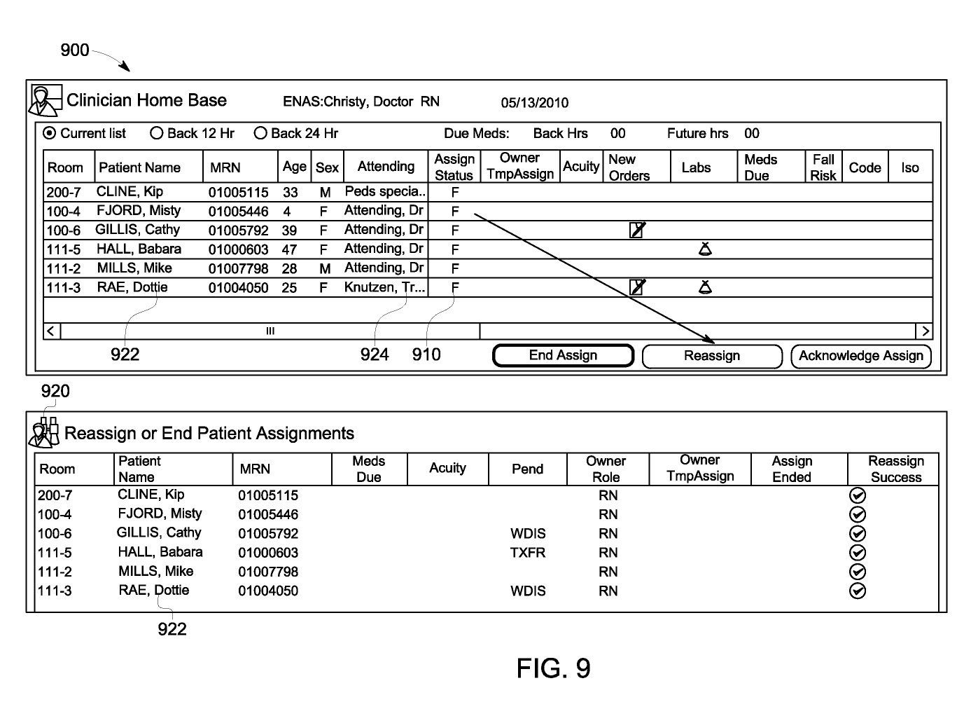

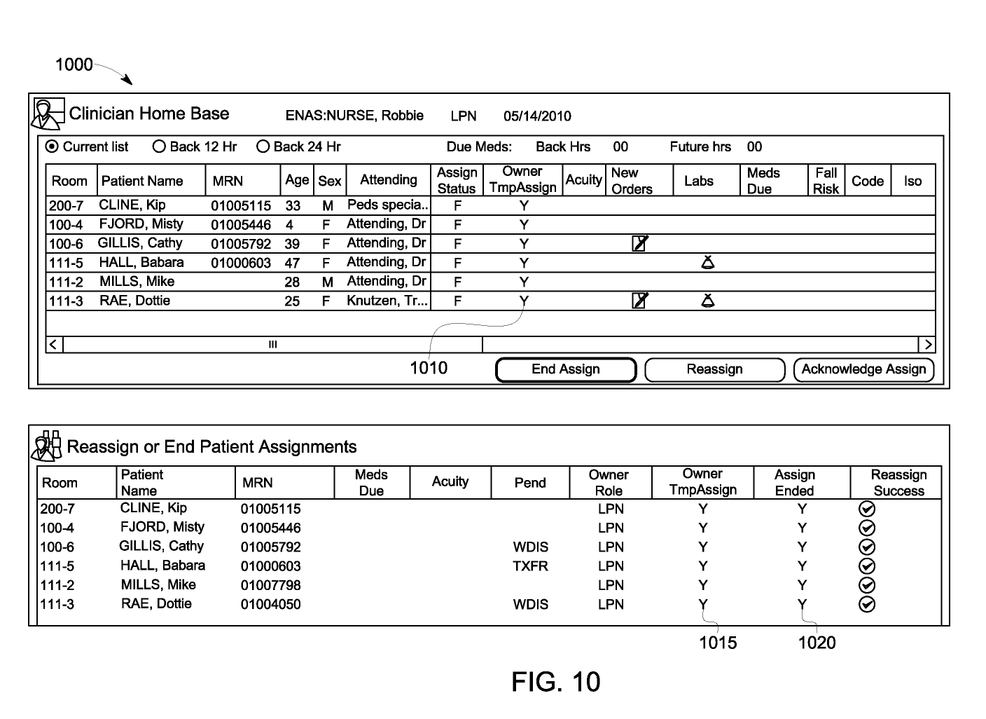

FIG. 9 depicts an example clinician interface 900 in which an assignment status 910 is reassigned using a reassign or end patient assignment interface 920. Via the interface 920, one or more patients 922 and an associated clinician 924 can be selected for reassignment. As shown in the example interface 1000 of FIG. 10, reassignment can be temporary (e.g., a clinician is on break, is called away, etc.) and/or “permanent”, for example. A temporary assignment status indicator 1010 allows an assignment to be made temporarily and then revert back to a previous assignment (e.g., manually via the interface 1000 and/or after a certain elapsed time, according to a schedule, etc.), for example. As shown in FIG. 10, a user can make a temporary reassignment 1015, end an assignment 1020, etc.

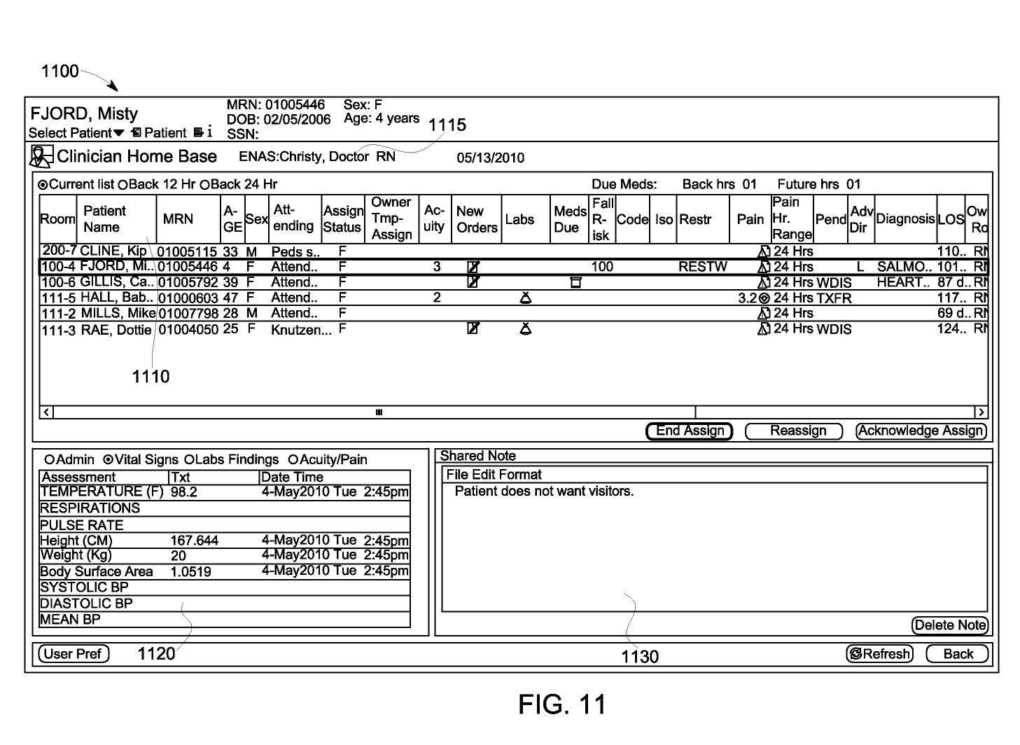

FIG. 11 depicts an example home base interface 1100. The interface 1100 includes a patient list 1110 for a clinician 1115, along with assignment, status, order, assessment, and/or other information for one or more patients in the list 1110. Using the interface 1100, patient information 1120 (e.g., assessment, text, date, time, etc.) and/or one or more shared notes 1130 can be provided.

Nursing assignment information can feed into the home base 1100. A color-coded and/or other visual indicator can alert a user to new patient(s) on a clinician's list. Additionally, a user can be alerted to new lab results for a patient, new orders, medications due within a certain time frame for a patient, etc. The alerts and/or other visual cues can be configurable for a user. In certain examples, a user can drill down from a flowsheet charting module by clicking on a value in the home base 1100 to launch flowsheet module and then return to the home base interface 1100. Using a flowsheet, acuity, pain value, lab information, etc., can be completed. A graphical trend (e.g., a red arrow) can be displayed with respect to one or more items, for example.

Using HomeBase 1100, clinicians can display patient data reflecting Stat orders and/or labs, meds/non-meds that are overdue and due now based on established time periods, diagnoses, indications of advanced directives completed by a patient, assessment and risk calculation of patient falls, and can manage pain assessment/reassessment, for example. Clinicians can use the example interface 1100 for single click navigation to update clinical data, such as pain assessment, acuity, fall risk, as well as review a visual indication to trend patient response to pain management.

The example home base interface 1100 includes configurable column headings, for example, along with pain logic and alerting, lab review alerting, adaptive scrolling, medications due/overdue, Stat order alerting, etc. Using the example interface 1100, a user can “drill down” to add and review assessment data, update acuity and/or pain values from their columns, access a flowsheet for fall risk from its column in the interface 1100, etc. The interface 1100 provides a display of current nursing assignments with roles and temporary versus permanent status and preliminary versus final status. The interface 1100 provides access to reassign patients temporarily and/or permanently and to review past patient assignments (e.g., up to twenty-four hours), for example.

Clinicians can use the Clinician Home Base 1100 to assist in organizing and prioritizing patient care activities during a shift. Using the clinician's active patient list, the interface 1100 shows a condensed view of pertinent details about each patient and provides alerts for activities such as new orders review, medication due charting, new lab results, etc.

From the Clinician Home Base 1100, clinicians can go to specific functions such as worklist charting or new order review by clicking on the corresponding cell in the table. The bottom portion of the example Clinician Home Base 1100 displays patient-specific findings and any shared notes for the current admission, for example.

The Clinician Home Base 1100 provides a single screen for clinicians to aid in accessing patient information. Clinicians can review and work with pertinent information for the patients they are taking care of on a specific shift. The Clinician Home Base screen 1100 can be configured to include information about patient demographics, assessments (e.g., findings), diagnoses, acuity, fall risk, pain, specific orders (e.g., code status), and nurse assignments, for example. The Clinician Home Base screen can include links to associated applications. For example, if a user clicks on or otherwise selects in a New Order column for a patient, the system launches an Order List, from which a user can update or review orders. The Clinician Home Base screen 1100 includes a free-text note box also referred to as an Admission Shared Note. In this box, a user can directly add and delete the admission shared note.

A clinical can use the Clinician Home Base module 1100 to review patient data such as Attending Provider, Acuity, Pending Discharge and Transfer, Advance Directive, Diagnosis, etc. A user can reassign patients to different clinicians, temporarily or permanently, end assignments, etc. A user can quickly access screens for updating findings such as acuity, pain, and fall risk, review or add Flowsheet data, receive alerts about medications due, access lab results, read shared patient notes, and add patient notes, for example.

The Clinician Home Base screen 1100 can be used to organize an active patient list. The interface 1100 can be used as a base from which a user can review a condensed list of pertinent details about each patient. In addition, a user can navigate to certain specific functions such as charting and new order review, patient-specific findings, shared notes for the current admission, patient reassignment, etc.

Patient data and provider information can be reviewed on the Clinician Home Base screen 1100, including assignment status, code, pain time range, etc. Assignment status indicates if the patient's assignment to the list owner is preliminary or final, and if the assignment is a temporary for the patient. Code, isolation (Iso), or restraint (Restr) indicates if the patient has specific orders related to codes, isolation, or restraints. Pain Hr Range describes a time frame of a most recent pain assessment on the patient's record. Other information such as advanced directives for the patient, length of stay (LOS), and diagnosis may be provided.

Clinician home base and nursing assignments work together to organize and assign (e.g., temporarily and/or permanently until a next change) patients to clinicians, for example.

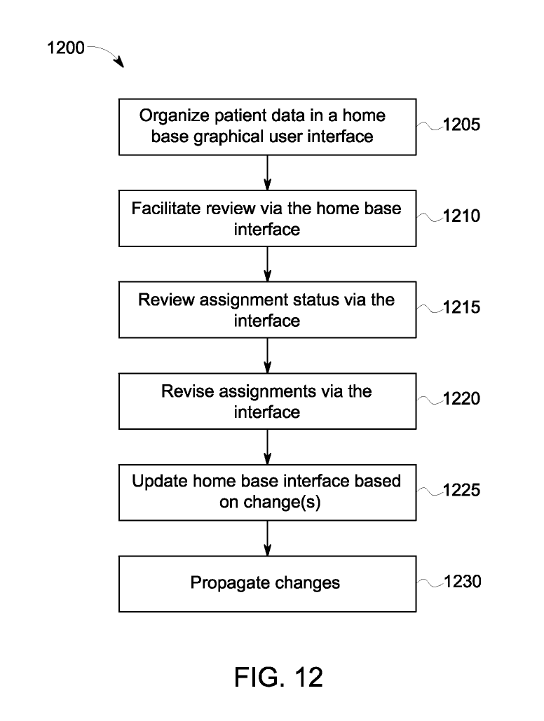

FIG. 12 provides a flow diagram for a method 1200 to manage patients assigned to a clinician. At block 1205, patient data is organized for one or more selected clinicians in a “home base” graphical user interface. At block 1210, review of patients, assigned clinician (e.g., doctor and/or nurse, attending, etc.), patient status, assignment status, order status, etc., is facilitated via the home base interface.

At block 1215, patients assigned to a clinician and assignment status is reviewed via the home base interface. For example, patients assigned to a nurse and nurses associated with an attending physician can be viewed, along with an indication of whether an assignment is temporary (e.g., to cover a nurse's break). At block 1220, assignments can be revised via the interface. For example, at a shift change, patients can be assigned from one nurse to another available nurse. As a patient moves to a different department, a new nurse and/or doctor can be assigned to that patient via the interface, for example.

At block 1225, the information in the home base interface is updated based on change(s) made. At block 1230, changes in assignment and/or other information can be propagated. For example, a change in a patient assignment can be propagated to a status report, chart, clinician home base, monitoring application, electronic record, etc.

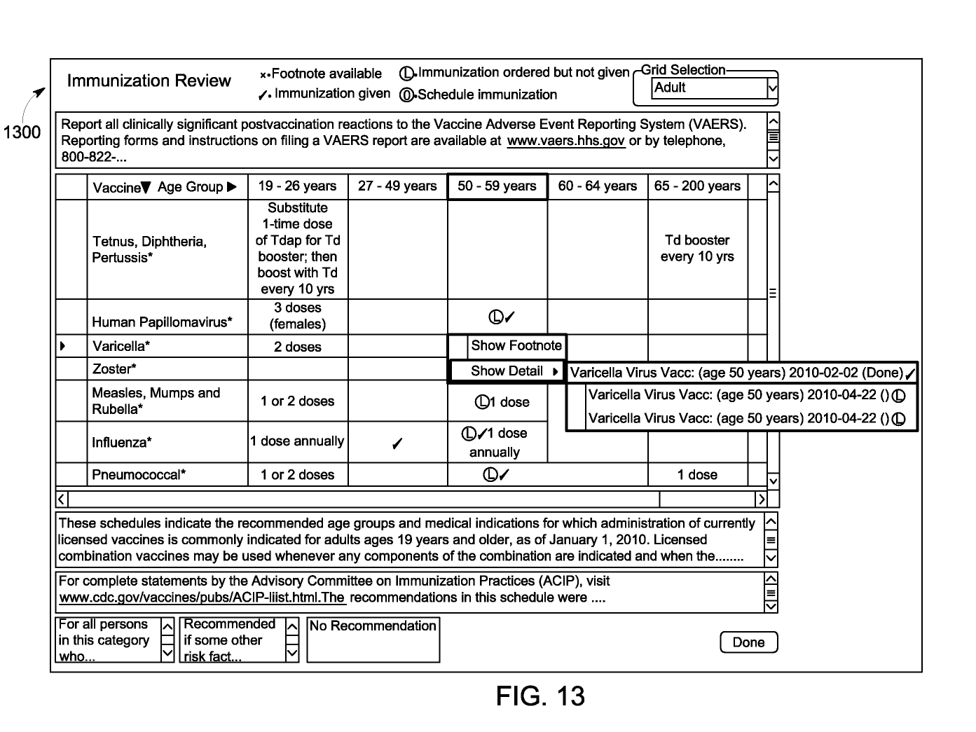

FIG. 13 illustrates an example immunization review interface 1300. The interface 1300 shows a profile of what a patient has received (e.g., DPTs, polios, etc.). The interface 1300 also provides a view of the CDC website indicating that this patient needs particular immunization(s) and comparing what the patient needs with what he or she has already taken/been prescribed. Certain examples import (and analyze) CDC content, make a schedule, and then superimpose the schedule over existing patient immunization/prescription information. Thus, immunization review is enhanced by displaying a patient's vaccine scheduling in conjunction with CDC directives such that overdue vaccines are highlighted and a mechanism is provided for inputting CDC immunization schedules.

Using the Immunizations module 1300, clinicians can review patient immunization information and record immunizations administration, both current and historical. In addition, the module 1300 provides immunization records management and printed reports. Using the example interface 1300, a user can view a patient's historical record from a single screen. Categories can be determined and customized based on user, unit, facility, etc. Data entry and management can be handled on separate screens. In certain examples, patient disease information relevant to immunization history, such as whether the patient has had measles or mumps, can be displayed. In certain examples, a copy of the immunization record can be printed and provided to the patient. In certain examples, there is also a more comprehensive report available for the patient's immunization history. In certain examples, the immunizations module 1300 is integrated with and supports ordering and charting.

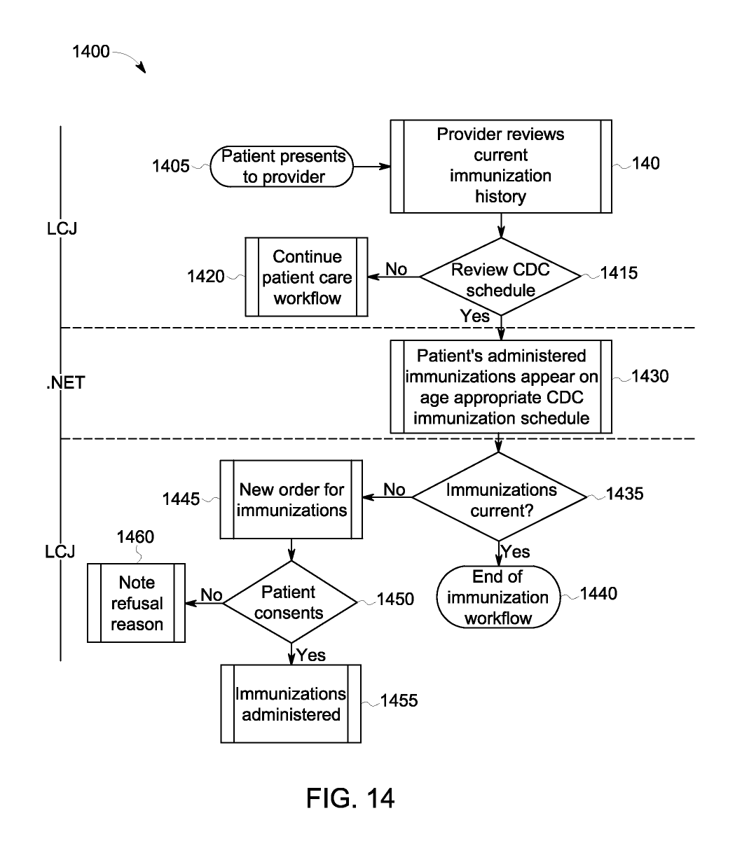

FIG. 14 illustrates a flow diagram for a method 1400 to view a patient's current administered immunizations and schedule immunizations based on a displayed age appropriate CDC immunization schedule. At block 1405, a patient presents to a care provider. At block 1410, the provider reviews current immunization history. At block 1415, the provider may choose to review the patient's current administered immunizations on a CDC age appropriate schedule. At block 1420, if the provider chooses not to review the CDC schedule, then he or she continues with a patient care workflow. If the provider chooses to see the patient's administered immunization history on the current age appropriate CDC schedule, then, at block 1430, a button is clicked and a screen (e.g., a .NET screen) is displayed. At block 1435, the provider determines whether the patient immunization schedule is current with the age appropriate CDC. If it is not, the user continues with the patient care workflow. If the schedule is current, then, at block 1440, the immunization workflow ends. At block 1445, immunizations can be ordered. Once the immunizations are ordered, at block 1450, patient consent is determined. At block 1455, if the patient consents, immunizations are administered. At block 1460, if the patient refuses, the provider notes the refusal reason.

Thus, an example immunization review interface shows what the recommended schedule is and where the patient is with respect to that recommendation. In certain examples a user can chart against the CDC schedule directly via the interface. In certain examples, footnotes with links can be viewed, including a footnote for a given disease/immunization (e.g., MMR), reproduced from the CDC website. A user can review what is recommended, evaluate a next step, place an order, chart, and send a call to a registry via the example interface.

While an example manner of implementing systems and methods have been illustrated in the figures, one or more of the elements, processes and/or devices illustrated in the figures may be combined, divided, re-arranged, omitted, eliminated and/or implemented in any other way. Further, one or more components and/or systems may be implemented by hardware, software, firmware and/or any combination of hardware, software and/or firmware. Thus, for example, any of the example components and/or systems may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example components and/or systems are hereby expressly defined to include a tangible medium such as a memory, DVD, Blu-ray, CD, etc., storing the software and/or firmware. Further still, any of the example systems may include one or more elements, processes and/or devices in addition to, or instead of, those illustrated in the figures, and/or may include more than one of any or all of the illustrated elements, processes and devices.

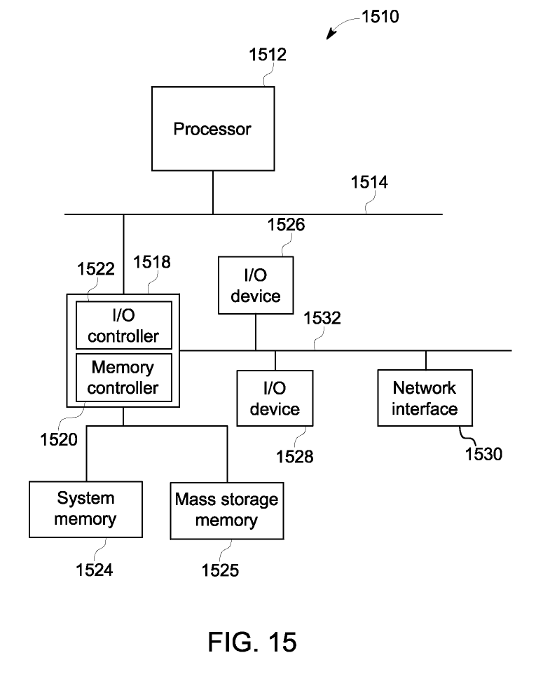

Flow diagrams and/or data flow depicted in and/or associated with the figures are representative of machine readable instructions that can be executed to implement example processes and/or systems described herein. The example processes may be performed using a processor, a controller and/or any other suitable processing device. For example, the example processes may be implemented in coded instructions stored on a tangible medium such as a flash memory, a read-only memory (ROM) and/or random-access memory (RAM) associated with a processor (e.g., the example processor 1512 discussed below in connection with FIG. 15). Alternatively, some or all of the example processes may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes may be implemented manually or as any combination(s) of any of the foregoing techniques, for example, any combination of firmware, software, discrete logic and/or hardware. Further, although the example processes are described with reference to the figures, other methods of implementing the processes of may be employed. For example, an order of execution may be changed, and/or some of the elements described may be changed, eliminated, sub-divided, or combined. Additionally, any or all of the example processes of may be performed sequentially and/or in parallel by, for example, separate processing threads, processors, devices, discrete logic, circuits, etc.

FIG. 15 is a block diagram of an example processor system 1510 that may be used to implement the systems, apparatus and methods described herein. As shown in FIG. 15, the processor system 1510 includes a processor 1512 that is coupled to an interconnection bus 1514. The processor 1512 may be any suitable processor, processing unit or microprocessor. Although not shown in FIG. 15, the system 1510 may be a multi-processor system and, thus, may include one or more additional processors that are identical or similar to the processor 1512 and that are communicatively coupled to the interconnection bus 1514.

The processor 1512 of FIG. 15 is coupled to a chipset 1518, which includes a memory controller 1520 and an input/output (I/O) controller 1522. As is well known, a chipset typically provides I/O and memory management functions as well as a plurality of general purpose and/or special purpose registers, timers, etc. that are accessible or used by one or more processors coupled to the chipset 1518. The memory controller 1520 performs functions that enable the processor 1512 (or processors if there are multiple processors) to access a system memory 1524 and a mass storage memory 1525.

The system memory 1524 may include any desired type of volatile and/or non-volatile memory such as, for example, static random access memory (SRAM), dynamic random access memory (DRAM), flash memory, read-only memory (ROM), etc. The mass storage memory 1525 may include any desired type of mass storage device including hard disk drives, optical drives, tape storage devices, etc.

The I/O controller 1522 performs functions that enable the processor 1512 to communicate with peripheral input/output (I/O) devices 1526 and 1528 and a network interface 1530 via an I/O bus 1532. The I/O devices 1526 and 1528 may be any desired type of I/O device such as, for example, a keyboard, a video display or monitor, a mouse, etc. The network interface 1530 may be, for example, an Ethernet device, an asynchronous transfer mode (ATM) device, an 802.11 device, a DSL modem, a cable modem, a cellular modem, etc. that enables the processor system 1510 to communicate with another processor system.

While the memory controller 1520 and the I/O controller 1522 are depicted in FIG. 15 as separate blocks within the chipset 1518, the functions performed by these blocks may be integrated within a single semiconductor circuit or may be implemented using two or more separate integrated circuits.

Certain examples contemplate methods, systems, apparatus, and/or computer program products on any machine-readable media to implement functionality described above. Certain examples may be implemented using an existing computer processor, or by a special purpose computer processor incorporated for this or another purpose or by a hardwired and/or firmware system, for example.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method comprising:
displaying, via a user interface, assignments between a clinician and one or more patients including a status of each assignment between the clinician and each of the one or more patients;
facilitating, via the user interface, a change in at least one assignment via the user interface; and
propagating the change based on an update to assignment status via the user interface.

2. The method of claim 1, wherein the clinician comprises a nurse.

3. The method of claim 1, wherein the clinician comprises a physician assigned to one or more nurses, wherein each of the one or more nurses is assigned to one or more patients.

4. The method of claim 1, wherein the status of the assignment comprises a temporary status.

5. The method of claim 4, wherein the temporary status is to revert to a normal assignment status after a defined condition is met.

6. The method of claim 5, wherein the defined condition comprises at least one of a time period, a user selection, and a confirmation of information receipt.

7. The method of claim 1, wherein a change in at least one assignment is governed by rules restricting changes to assignments via the interface.

8. A tangible computer-readable storage medium including instructions for execution by a processor, the instructions when executed implementing a method to facilitate patient assignment, the method comprising:
displaying, via a user interface, assignments between a clinician and one or more patients including a status of each assignment between the clinician and each of the one or more patients;
facilitating, via the user interface, a change in at least one assignment via the user interface; and
propagating the change based on an update to assignment status via the user interface.

9. The computer-readable storage medium of claim 8, wherein the clinician comprises a nurse.

10. The computer-readable storage medium of claim 8, wherein the clinician comprises a physician assigned to one or more nurses, wherein each of the one or more nurses is assigned to one or more patients.

11. The computer-readable storage medium of claim 8, wherein the status of the assignment comprises a temporary status.

12. The computer-readable storage medium of claim 11, wherein the temporary status is to revert to a normal assignment status after a defined condition is met.

13. The computer-readable storage medium of claim 12, wherein the defined condition comprises at least one of a time period, a user selection, and a confirmation of information receipt.

14. The computer-readable storage medium of claim 8, wherein a change in at least one assignment is governed by rules restricting changes to assignments via the interface.

15. A system comprising a processor and a memory, the memory storing instructions to enable the processor to implement a user interface arranged to:
display assignments between a clinician and one or more patients including a status of each assignment between the clinician and each of the one or more patients;
facilitate a change in at least one assignment via the user interface; and
propagate the change based on an update to assignment status via the user interface.

16. The system of claim 15, wherein the clinician comprises a nurse.

17. The system of claim 15, wherein the clinician comprises a physician assigned to one or more nurses, wherein each of the one or more nurses is assigned to one or more patients.

18. The system of claim 15, wherein the status of the assignment comprises a temporary status.

19. The system of claim 18, wherein the temporary status is to revert to a normal assignment status after a defined condition is met.

20. The system of claim 19, wherein the defined condition comprises at least one of a time period, a user selection, and a confirmation of information receipt.
